(19) United States
(12) Patent Application Publication
(10) Pub. No.: US 2023/0390144 A1
(43) Pub. Date: Dec. 7, 2023

(54) MASSAGING DEVICE

(71) Applicant: SHENZHEN SVAKOM TECHNOLOGY CO., LTD, Shenzhen (CN)

(72) Inventors: MINCHAO HE, Shenzhen (CN); Yong Yu, Shenzhen (CN); Yongqing Wang, Shenzhen (CN); Guohui Zhang, Shenzhen (CN)

(21) Appl. No.: 17/978,992

(22) Filed: Nov. 2, 2022

Related U.S. Application Data
(63) Continuation-in-part of application No. 17/833,865, filed on Jun. 6, 2022.

(30) Foreign Application Priority Data
Sep. 26, 2022 (CN) 202222572376.2

(51) Int. Cl. A61H 9/00

(52) U.S. Cl. CPC A61H 9/0057; A61H 9/0007; A61H 9/0071; A61H 2201/0228; A61H 2201/0285; A61H 2201/10; A61H 2201/0207; A61H 2201/0214; A61H 2201/5071

(57) ABSTRACT

The present disclosure provides a massaging device, which includes an outer housing defining a first opening; a negative pressure generator received in the outer housing; and a driving assembly received in the outer housing, the drive assembly is configure to drive the negative pressure generator to generate alternating positive and negative pressures at the first opening. The massaging device of present disclosure has a better massaging effect.

### CROSS-REFERENCE TO RELATED APPLICATIONS

The application claims priority of Chinese patent application CN202222572376.2, filed on Sep. 26, 2022, which is incorporated herein by reference in its entirety.

### FIELD

The present disclosure relates to the field of massaging apparatus, and in particular to a massaging device.

### BACKGROUND

With the accelerated pace of life, working pressures on people are increased. After daily working, a person may be tired, various portions of a body may ache. In order to relieve fatigue and soreness, people may take a variety of massaging devices to massage the body, such as a negative pressure massaging device. The negative pressure massaging device may adsorb and relax the skin to relieve the fatigue and soreness, so as to sooth the physically and mentally. However, the massaging device in the related art may have a poor adsorption effect.

Therefore, the massaging device in the related art needs to be improved to avoid the above defects.

### SUMMARY

In view of the above-mentioned defects in the related art, the present disclosure provides a massaging device for solving the problem of that the existing massaging device has a poor adsorption effect.

To achieve the above purpose, the present disclosure provides a massaging device, which includes an outer housing defining a first opening, a negative pressure generator received in the outer housing, and a driving assembly received in the outer housing, the drive assembly is configure to drive the negative pressure generator to generate alternating positive and negative pressures at the first opening.

In at least one embodiment, the negative pressure generator includes: a first housing received in the outer housing, and a movable member, the first housing defines a second opening and a receiving space communicated with the second opening, the movable member is extended into the receiving space, a gap is defined between the movable member and the first housing, the gap is greater than 0.1 mm and no greater than 5 mm, and the movable member is configured to reciprocate in the receiving space driven by the driving assembly, to generate alternating positive and negative pressures at the first opening and the second opening.

In at least one embodiment, the massaging device further includes at least one temperature adjusting member arranged in the outer housing.

In at least one embodiment, the temperature adjusting member is at least one of a semiconductor chilling plate, a heating coil, and an infrared heating assembly.

In at least one embodiment, the infrared heating assembly includes a first circuit board and at least one LED red globe lamp electrically connected with the first circuit board, the LED red globe lamp is configured to face the first opening.

In at least one embodiment, the infrared heating assembly further includes a cover plate configured to cover the LED red globe lamp, the cover plate is transparent, or the cover plate is transparent and waterproof.

In at least one embodiment, the temperature adjusting member is arranged on an outer wall of the movable member; or the temperature adjusting member is disposed on a side of the movable member facing the second opening; the temperature adjusting member is accommodated in an accommodating space defined in the movable member.

In at least one embodiment, the negative pressure generator further includes a sealing member sleeved on the movable member, and the gap is defined between the sealing member and the inner wall of the first housing.

In at least one embodiment, the massaging device further includes a support housing defining a third opening communicated with the first opening and the second opening, the first housing is received in the support housing, and the outer housing is sleeved on the support housing.

In at least one embodiment, the massaging device further include a second housing connected with a side of the first housing away from the movable member, the second housing defines a through hole communicated with the second opening, and the temperature adjusting member is arranged in the second housing.

In at least one embodiment, the second housing is flexible.

In at least one embodiment, the temperature adjusting member is provided on a side of the second housing away from the first housing.

In at least one embodiment, the temperature adjusting member is disposed adjacent to the first opening.

In at least one embodiment, the massaging device further includes an electrode sheet received in the first opening.

In at least one embodiment, the massaging device further includes a battery and a second circuit board, the temperature adjusting member is electrically connected with the battery and the second circuit board.

In at least one embodiment, the massaging device further includes at least one pressure sensor received in the outer housing and disposed adjacent to the first opening.

In at least one embodiment, the massaging device further includes: a third housing arranged in the outer housing, a movable member connected with the third housing, and a driving assembly, the third housing is flexible, the third housing is connected with the outer housing to define an adsorbing chamber communicated with the first opening, the driving assembly is configured to drive the movable member to reciprocally move, so as to generate alternating positive and negative pressures at the first opening.

In at least one embodiment, the negative pressure generator includes a support housing having an accommodation portion, and a movable member extended into the accommodation portion, a gap is defined between the movable member and the accommodation portion, the gap is greater than 0.1 mm and no greater than 5 mm, and the movable member is configured to reciprocate in the accommodation portion driven by the driving assembly, to generate the alternating positive and negative pressures at the first opening.

In at least one embodiment, the support housing defines a receiving groove, the outer housing includes a sub-housing, the sub-housing is at least partially received in the receiving groove in a detachable manner.

In at least one embodiment, the outer housing includes a sub-housing, the first housing is integrally formed with the sub-housing.

In the technical solution of the present disclosure, the massaging device includes an outer housing and a negative pressure massaging device, the drive assembly can drive the negative pressure generator to generate alternating positive and negative pressures at the first opening. Therefore, the massaging device of the present disclosure has a better adsorption effect.

### BRIEF DESCRIPTION OF THE DRAWINGS

Implementations of the present disclosure will now be described, by way of embodiment, with reference to the attached FIGS. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a cross sectional view of a massaging device according to a first embodiment of the present disclosure.

FIG. 2 is an enlarged view of portion A in FIG. 1.

FIG. 3 is a cross sectional view of some components of a massaging device according to a second embodiment of the present disclosure.

FIG. 4 is a cross sectional view of some components of a massaging device according to a third embodiment of the present disclosure.

FIG. 5 is a cross sectional view of some components of a massaging device according to a fourth embodiment of the present disclosure.

FIG. 6 is a cross sectional view of a massaging device according to a fifth embodiment of the present disclosure.

FIG. 7 is an enlarged view of portion B in FIG. 6.

FIG. 8 is a cross sectional view of a massaging device according to a sixth embodiment of the present disclosure.

FIG. 9 is a cross sectional view of a massaging device according to a seventh embodiment of the present disclosure.

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

It is to be understood that, all of the directional instructions in the exemplary embodiments of the present disclosure (such as top, down, left, right, front, back) can only be used for explaining relative position relations, moving condition of the elements under a special form (referring to figures), and so on, if the special form changes, the directional instructions changes accordingly.

In addition, the descriptions, such as the “first”, the “second” in the present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

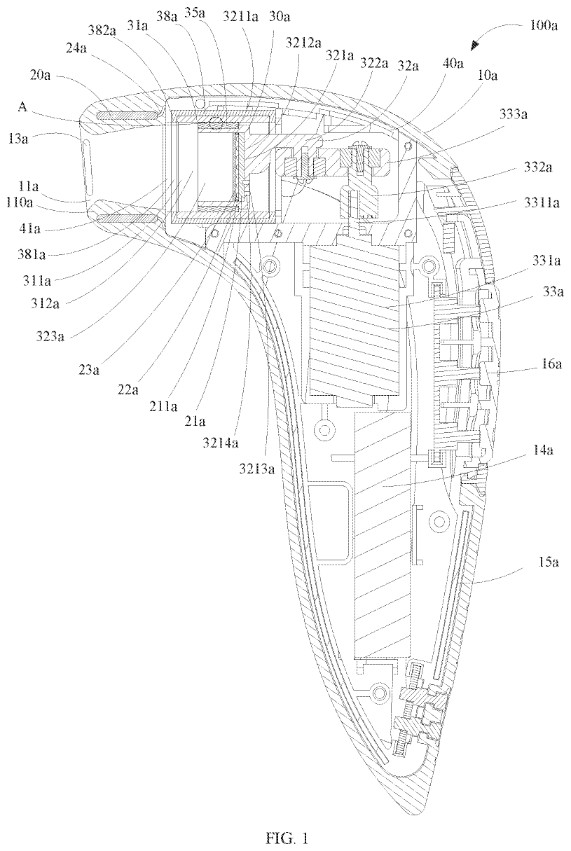

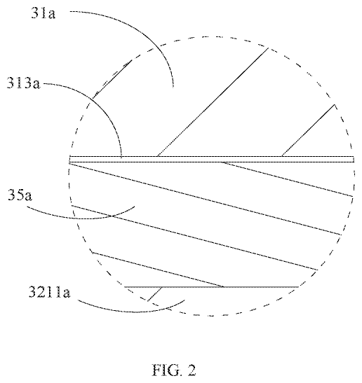

Referring to FIGS. 1-2, the present disclosure provides a massaging device 100a according to a first embodiment, the massaging device 100a can be used to massage a body of a user.

The massaging device 100a includes an outer housing 10a defining a first opening 11a, a negative pressure generator 30a received in the outer housing 10a, and a driving assembly 33a received in the outer housing 10a, the drive assembly 33a is configure to drive the negative pressure generator 30a to generate periodic alternating positive and negative pressures at the first opening 11a. The outer housing 10a includes a massage portion 110a which defines the first opening 11a.

The outer housing 10 is made of a skin-friendly material, such as silicone, rubber, or plastic, so as to improve a user experience. The first opening 11a can be used as a sucking port configured for massaging the body.

The massaging device 100a further includes at least one temperature adjusting member 20a arranged in the outer housing 10a. The temperature adjusting member 20a is disposed adjacent to the first opening 11a. The temperature adjusting member 20a is at least one of a semiconductor chilling plate, a heating coil, and an infrared heating assembly. An area adjacent to the first opening 11a can be heated or cooled by switching a cold side or a hot side of the semiconductor chilling plate. The outer housing 10 defines a via hole 24a, a wire of the temperature adjusting member 20a can pass through the via hole 24a to connect the battery 14a with the second circuit board 15a.

The infrared heating assembly includes a first circuit board 21a, at least one LED red globe lamp 22a electrically connected with the first circuit board 21a, and a cover plate 23a, the LED red globe lamp 22a faces the first opening 11a. The cover plate 23a covers the LED red globe lamp 22a, and the cover plate 23a is transparent and waterproof. The cover plate 23a can be connected with the first circuit board 21a by a connecting element 211a, and can cover the LED red globe lamp 22a to protect the LED red globe lamp 22a. The connecting element 211a can be a glue or the like. A quantity of the LED red globe lamp 22a can be more than one, so as to improve a heating effect. The red light emitted by the LED red globe lamp 22a can penetrate into an inner layer of skin, to accelerate a cell generation, inhibit a cell aging, and promote a formation of dermal collagen. The red light emitted by the LED red globe lamp 22a can also improve a local blood circulation, accelerate a wound healing, and promote an inflammation resolution. Therefore, the massaging device 100a has anti-inflammatory and antibacterial effects.

The massaging device 100a further includes an electrode sheet 13a received in the first opening 11a. The electrode sheet 13a can be received in the first opening 11a by a connecting piece (not shown) which can be connected to a wall of the first opening 11a. The electrode sheet 13a can emit micro-current, which can act on human skin to stimulate a production of adenosine triphosphate (ATP) and a vitality of facial muscles, and promote productions of collagen and elastin, so as to massage and beautify the body.

In one embodiment, the electrode sheet 13a can be in a sheet shape or a strip shape. In another embodiment, the electrode sheet 13a can also be designed as a cylindrical protrusion.

The massaging device 100a also includes a battery 14a and a second circuit board 15a, and the temperature regulator 20a and the electrode sheet 13a are both electrically connected with the battery 14a and the second circuit board 15a.

The massaging device 100a further includes a button 16a, the button 16a is electrically connected with the battery 14a and the second circuit board 15a, and the button 16a is used to control an operation of the massaging device 100a. The button 16a is at least partially exposed from the outer housing 10a, or the button 16a is attached to an inner surface of the outer housing 10a.

In the technical solution of the present disclosure, the massaging device 100a includes an outer housing 10a, a negative pressure massaging device 30a, and at least one temperature adjusting member 20a. The drive assembly 33a can drive the negative pressure generator 30a to generate alternating positive and negative pressures at the first opening 11a. Therefore, the massaging device 100a of the present disclosure has a better adsorption effect. The temperature adjusting member 20a is arranged in the outer housing 10a, so that the massaging device 100a can not only massage the body, but also adjust a temperature of the massaging area by heating or cooling the massaging area. Therefore, the massaging device 100a of the present disclosure has multifunctionality.

The negative pressure generator 30a includes a first housing 31a received in the outer housing 10a, and a movable member 32a extended into the receiving space 312a. The first housing 31a defines a second opening 311a communicated with the first opening 11a, and a receiving space 312a communicated with the second opening 311a. A gap 313a (referring to FIG. 2) is defined between the movable member 32a and an inner wall of the first housing 31a, and the gap 313a is greater than 0.1 mm, and no greater than 5 mm. The massage portion 110a and the first housing 31a remain undeformed under actions of the negative pressure and the positive pressure, the first housing 31a and the massage portion 110a are two separate parts and made of different materials. The movable member 32a defines a reciprocation direction. A sectional size perpendicular to the reciprocation direction of the second opening 311a is substantially same as a sectional size perpendicular to the reciprocation direction of the first opening 11a.

The movable member 32a can be a piston.

The driving assembly 33a is configured to drive the movable member 32a to reciprocate in the receiving space 312a, so as to generate alternating positive and negative pressures at the first opening 11a and the second opening 311a. In detail, the drive assembly 33a drives the movable member 32a to linearly reciprocate in the receiving space 312a, and the movable member 32a reciprocates along a longitudinal direction of the first housing 31a.

The gap 313a is 0.12 mm, 0.14 mm, 0.16 mm, 0.18 mm, 0.2 mm, 0.3 mm, 0.4 mm, 0.5 mm, 0.6 mm, 0.7 mm, 0.8 mm, 0.9 mm, 1 mm, 1.5 mm, 2 mm, 2.5 mm, 3 mm, 3.5 mm, 4 mm, 4.5 mm, or 5 mm. The gap 313a is set to be greater than 0.1 mm, and no greater than 5 mm, so the massaging device 100a can not only generate the alternating positive and negative pressures at the first opening 11a and the second opening 311a, but also can reduce noise when in use.

The negative pressure generator 30a is electrically connected with the battery 14a and the second circuit board 15a. Specifically, the driving assembly 33a is electrically connected with the battery 14a and the second circuit board 15a.

The massaging device 100a further includes a support housing 40a, the negative pressure generator 30a is at least partially received in the support housing 40a, and the outer housing 10a is sleeved on the support housing 40a, the support housing 40a defines a third opening 41a, and both the first opening 11a and the second opening 311a are communicated with the third opening 41a.

The movable member 32a includes a free end 321a and a driving end 322a, the free end 321a defines an accommodating space 323a. An opening direction of the accommodating space 323a is substantially same as that of the receiving space 312a. The temperature adjusting member 20a can be received in the accommodating space 323a. The free end 321a includes a side wall 3211a and a bottom wall 3212a, the bottom wall 3212a is connected with the driving end 322a, and the side wall 3211a is extended from the bottom wall 3212a in a direction towards the first opening 11a, so the bottom wall 3212a and the side wall 3211a can cooperatively define the accommodating space 323a. The accommodating space 323a is communicated with the receiving space 312a. The accommodating space 323a allows a volume of the receiving space 312a to be increased, so that the pressure generator 30a can have a large pressure variation range and a large pressure variation space. At the same time, the accommodating space 323a can also increase a contact area between the movable member 32a and air in the receiving space 312a, such that the movable member 32a may be subjected to a uniform force while moving, and the movable member 32a may move stably.

The free end 321a is matched with the receiving space 312a in shape, Specifically, the free end 321a is U-shaped or cylindrical shaped.

The negative pressure generator 30a further includes a sealing member 35a, and the sealing member 35a is sleeved on the side wall 3211a of the movable member 32a. The sealing member 35a can be made of metal, preferably aluminum alloy or the like. The gap 313 may be defined between the inner wall of the first housing 31a and the sealing member 35a.

The sealing member 35a and the side wall 3211a are integrally formed, and the sealing member 35a and the side wall 3211a can be made of plastic. Preferably, the sealing member 35a and the side wall 3211a are integrally formed by an injection molding process.

The bottom wall 3212a defines at least one mounting hole 3213a, and a mounting member (not shown) such as a screw or a stud can pass through the mounting hole 3213a to connect the bottom wall 2312a with the circuit board 21a. The mounting hole 3213a can be a screw hole.

The bottom wall 3212a defines at least one first via hole 3214a, and a wire (not shown) of the first circuit board 21a can pass through the first via hole 3214a to electrically connect the first circuit board 21a with the battery 14a.

The negative pressure generator 30a further includes a protective cover 38a sleeved an outside of the first housing 31a. The protective cover 38a defines an opening 381a communicated with the second opening 311a. The protective cover 38a is made of buffer material, such as silicone. The protective cover 38a is sandwiched and installed between the support housing 40a and the first housing 31a. By arranging the protective sleeve 38a, transmission of vibration to the outside may be reduced, and on the other hand, transmission of noise, which is generated due to the movable member 32a moving while the movable member 32a contacts the first housing 31a, to the outside may be reduced, such that noise may be reduced.

A block 382a is arranged at each of two ends of the protective sleeve 38a, and the block 382a extends towards the receiving space 312a. Two blocks 351 define a receiving cavity (not shown) for receiving the first housing 31a. The outside of the first housing 31a is sleeved by the protective sleeve 38a for wrapping, which can further reduce noise. The block 382a may be a convex block, and a plurality of blocks 382a may be spaced apart from each other and disposed between the two ends of the protective sleeve 38a. Alternatively, the block 382a may be a ring-shaped wall, and two blocks 351 may be disposed at the two ends of the protective sleeve 38a respectively.

The drive assembly 33a includes a motor 331a, an eccentric member 332a connected with an output shaft 3311a of the motor 331a, and a connecting rod 333a connected with the eccentric member 332a. The connecting rod 333a is connected with an end of the driving end 322a away from the free end 321a.

In the technical solution of the present disclosure, the negative pressure generator 30a of the massaging device 100a includes the first housing 31a and the movable member 32a, the movable member 32a extends into the receiving space 312a of the first housing 31a, the driving assembly 33a can drive the movable member 32a to reciprocate in the receiving space 312a, so as to generate periodic alternating positive and negative pressures at the first opening 11a, thereby stimulating and massaging human skin. Specifically, when the first opening 11a of the massaging device 100a is adsorbed on the human skin, the receiving space 312a is in a closed state, and the reciprocating motion of the movable member 32a can change the volume of the receiving space 312a of the first housing 31a, so that the internal air pressure of the receiving space 312a dynamically changes, to generate alternate positive and negative pressures.

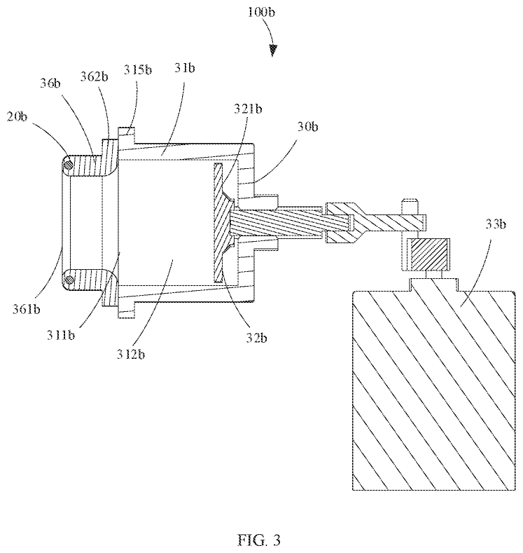

Referring to FIG. 3, a second embodiment of the present disclosure provides a massaging device 100b, the structure of the massaging device 100b is similar to the massaging device 100a. The differences between the two at least include: the free end 321b of the movable member 32b of the negative pressure generator 30b is flat; the massaging device 100b further includes a second housing 36b, and the second housing 36b is connected with an end of the first housing 31b away from the free end 321b, the second housing 36b defines a first through hole 361b communicated with the second opening 311b; the temperature adjusting member 20b is arranged in the second housing 36b.

The second housing 36b may be flexible. In one embodiment, the first housing 31b and the second housing 36b are integrally formed. In another embodiments, the first housing 31b and the second housing 36b can also be connected by means of gluing or the like.

The temperature adjusting member 20b is arranged on a side of the second housing 36b away from the first housing 31b. The temperature adjusting member 20b may be a heating coil or a semiconductor chilling plate.

The first housing 31b is protruded with at least one first protrusion 315b, the second housing 36b is protruded with at least one second protrusion 362b, the first protrusion 315b is connected with the second protrusion 362b to increase a contact area between the first housing 31b and the second housing 36b, further to increase a connecting strength between the first housing 31b and the second housing 31b. The first protrusion 315b is disposed around the outer surface of the first housing 31b, and disposed adjacent to the second opening 311b. The second protrusion 362b is disposed around the outer surface of the second housing 36b and disposed adjacent to the second opening 311b.

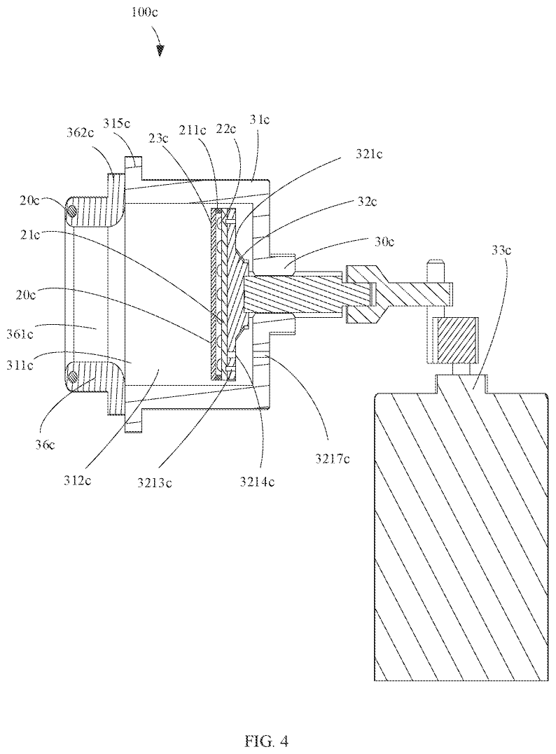

Referring to FIG. 4, the present disclosure provides a massaging device 100c according to a third embodiment, the massaging device 100c is similar to the massaging device 100b in structure. The differences between the two at least include: the free end 321c of the movable member 32c of the negative pressure generator 30c is provided with the temperature adjusting member 20c which can be the infrared heating assembly, the infrared heating assembly includes the first circuit board 21c, at least one LED red globe lamp 22c electrically connected with the first circuit board 21c, and the cover plate 23c, the LED red globe lamp 22c faces the second opening 311c, the cover plate 23c covers the LED red globe lamp 22c, and the cover plate 23c is transparent.

The cover plate 23c may be connected with the first circuit board 21c by a connecting element 211c, and cover the LED red globe lamp 22c to protect the LED red globe lamp 22c. The connecting member 211c can be a glue or the like. A quantity of the LED red globe lamp lamp 22c can be more than one, so as to improve the heating effect.

The infrared heating element is arranged on a side of the free end 321c facing the second opening 311c.

The temperature adjusting member 20c is disposed on a side of the second housing 36c away from the first housing 31c. The temperature adjusting member 20c may be disposed adjacent to the first through hole 361c.

At least one first protrusion 315c is protruded from the first housing 31c, at least one second protrusion 362c is protruded from the second housing 36c, and the first protrusion 315c is connected with the second protrusion 362c to increase a contact area between the first housing 31c and the second housing 36c, thereby increasing a connection strength between the first housing 31c and the second housing 36c.

The free end 321c which is received in the receiving space 312c defines at least one mounting hole 3213c, and a mounting member (not shown) such as a screw can pass through the mounting hole 3213c to connect the free end 321c with the circuit board 21c.

The free end 321c defines at least one first via hole 3214a, the first housing 31c defines a second via hole 3217c, a wire (not shown) of the circuit board 21c can pass through the first via hole 3214a and the second via hole 3217c to electrically connect the circuit board 21c with the battery.

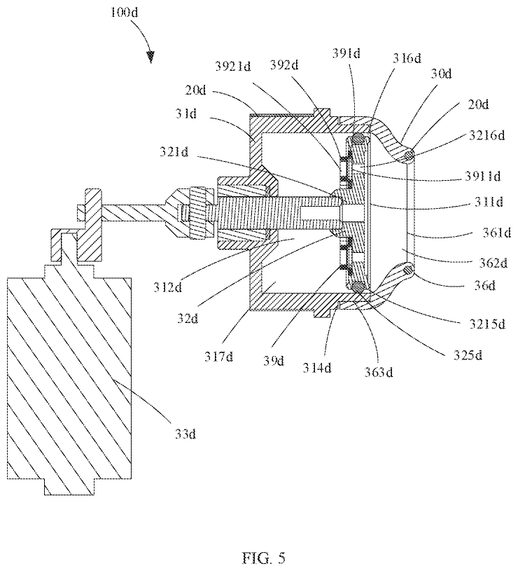

Referring to FIG. 5, a fourth embodiment of the present disclosure provides a massaging device 100d, the structure of the massaging device 100d is similar to the massaging device 100b. The difference between the two at least include: the free end 321d of the movable member 32d of the negative pressure generator 30d defines at least one exhaust hole 3216d, the massaging device 100d further includes at least one exhaust structure, and the exhaust structure can be an exhaust plug 39d, and the exhaust plug 39d includes a main body 391d fixed on the side of the free end 321d away from the second opening 311d, and a surrounding wall 392d connected with the main body 391d, the main body 391d defines a second through hole 3911d communicated with the exhaust hole 3216d, the surrounding wall 392d extends from a periphery of the second through hole 3911d in a direction away from the second opening 311d, and the surrounding wall 392d surrounds and forms a channel 3921d communicated with the second through hole 3911d; in a static state, the surrounding wall 392d closes the channel 3921d or substantially closes (there is only a small gap) the channel 3921d by its own elastic force; the massaging device 100d further includes a sealing member 325d, which can be used to seal and block the gap, and divide the receiving space 312d into a first cavity 316d and a second cavity 317d; the side wall 3211d of the first housing 31d is also provided with a temperature adjusting member 20d. The surrounding wall 392d is made of elastic material.

The temperature adjusting member 20d may be the semiconductor chilling plate, and the hot end of the semiconductor chilling plate can be set close to the side wall 3211d, or the cold end of the semiconductor chilling plate can be set close to the side wall 3211d. In other embodiments, the temperature adjusting member 20d may be the heating coil.

The free end 321d defines an accommodating groove 3215d, and the sealing member 325 can be received in the accommodating groove 3215d, and block and seal the gap. The accommodating groove 3215d may be defined around the free end 321d, and the sealing member 325 may also be annular shaped.

The first housing 31d defines a receiving groove 314d, and one end of the second housing 36d is received in the receiving groove 314d, to connect the first housing 31d with the second housing 36d. The second housing 36d is provided with a step 363d, and the step 363d is received in the receiving groove 314d.

It can be understood that when the free end 321d moves in a direction away from the second opening 311d, the volume of the first cavity 316d is increased to decrease the air pressure in the first cavity 316d (a difference between the air pressure in the first chamber 316d and the air pressure in the second chamber 317d is not sufficient to prevent a deformation of the surrounding wall 392d), therefore, the negative pressure is generated at the first opening 11a to generate a suction force applied on human body, the surrounding wall 392d closes under the action of negative pressure to block the communication between the second through hole 3911d and the second cavity 317d, and the surrounding wall 392d also remains close with the volume of the first cavity 316d getting bigger under the air pressure of the second cavity 317d.

It can be understood that, when the free end 321d moves in the direction toward the second opening 311d, the volume of the first cavity 316d is decreased to decrease the negative pressure. Then the free end 321d compresses air in the first cavity 316d to increase the air pressure in the first cavity 316d. When a difference between the air pressure in the first cavity 316d and the air pressure in the second chamber 317d (the air pressure in the first cavity 316d is greater than the air pressure in the second cavity 317d) is greater enough to make the surrounding wall 392d deform to open the channel 3921d, the channel 3921d is communicated with the second through hole 3911d and the second chamber 317d (that is, the first cavity 316d is communicated with the second chamber 317d by the second through hole 3911d, the channel 3921d, and the exhaust hole 3216d).

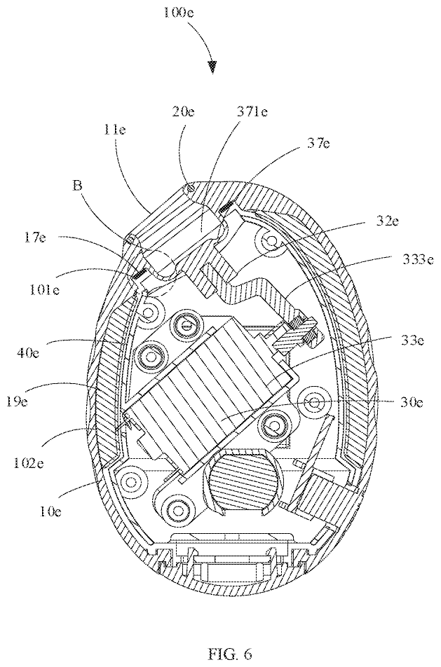

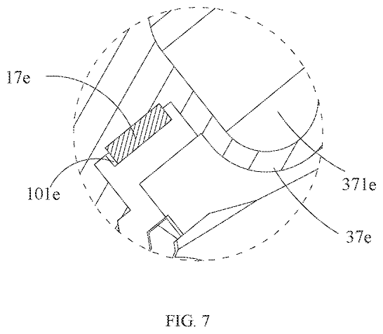

Referring to FIGS. 6-7, the present disclosure provides a massaging device 100e according to a fifth embodiment, the massaging device 100e is similar to the massaging device 100a in structure. The differences between the two at least include: the negative pressure generator 30e further includes a third housing 37e disposed in the outer housing 10a, the third housing 37e is flexible, and the third housing 37e is connected with the outer housing 10e to define an adsorbing chamber 371e communicated with the first opening 11e, the movable member 32e is connected with the third housing 37e, and the driving assembly 33e can drive the movable member 32e to push the third housing 37e back and forth, to change a volume of the adsorbing chamber 371e, further to generate periodical alternating positive and negative pressures at the first opening 11e.

The third housing 37e may be a flexible membrane. The third housing 37e may be integrated with the outer housing 10a. The third housing 37e may be integrated with the movable member 32e.

A portion of the third housing 37e facing the first opening 11e may also be provided with the temperature adjusting member. The temperature adjustment element is at least one of the semiconductor chilling sheet, the heating coil, and the infrared heating assembly.

A portion where the third housing 37e is connected to the movable member 32e may also be provided with the temperature adjusting member. The temperature adjustment element is at least one of the semiconductor chilling sheet, the heating coil, and the infrared heating assembly.

The movable member 32e is connected with a side of the third housing 37e away from the first opening 11e.

The massaging device 100e further includes at least one pressure sensor 17e, the pressure sensor 17e is received in the outer housing 10e and disposed adjacent to the first opening 11e. A temperature at the first opening 11e can be adjusted by a pressure value collected by the pressure sensor 17e. The inner wall of the outer housing 10 is recessed with at least one groove 101e, and the pressure sensor 17e can be received in the groove 101e.

The inner wall of the outer housing 10e is recessed with at least one groove 102e, and the massaging device 100e further includes at least one flexible pad 19e, and the flexible pad 19e is received in the groove 102e, and sandwiched between the outer housing 10e and the support housing 40e.

It can be understood that, the massaging devices according to the first to fourth embodiment can also include the pressure sensor, and can adjust the temperature at the first opening according to the pressure value collected by the pressure sensor.

The connecting rod 333e of the driving assembly 33e may be Z-shaped or S-shaped, so that the massaging device 100e is compact in structure.

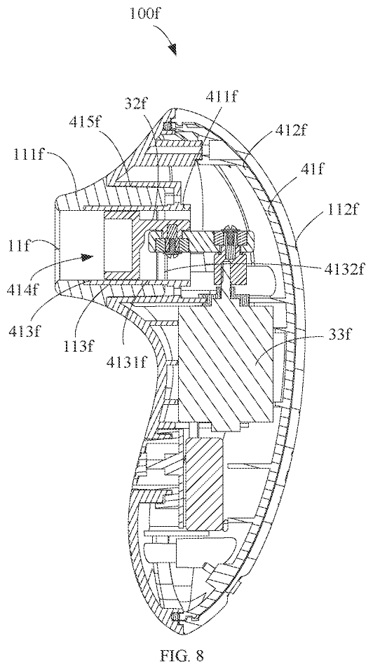

Referring to FIG. 8, a sixth embodiment of the present disclosure provides a massaging device 100f, the structure of the massaging device 100f is similar to the massaging device 100a. The differences between the two at least include: the outer housing 10f of the massaging device 100f includes a first sub-housing 111f and a second sub-housing 112f, the first sub-housing 111f can be used as a nozzle and defines the first opening 11f, the support housing 40f includes a first sub-support housing 411f and a second sub-support housing 412f connected to the first sub-support housing 411f, the first sub-support housing 411f is disposed between the first sub-housing 111f and the second sub-support housing 412f, the second sub-support housing 412f is disposed in the second sub-housing 112f, the movable member 32f of the negative pressure generator 30f is received in the first sub-support housing 411f, the gap (not labeled) is defined between the movable member 32f and an inner wall of the first sub-support housing 411f, the gap is greater than 0.1 mm, and no greater than 5 mm, the driving assembly 33f is configured to drive the movable member 32f to reciprocate in the first sub-support housing 411f, so as to generate periodic alternating positive and negative pressures at the first opening 11f.

The first sub-support housing 411f includes the accommodation portion 413f which defines an accommodation cavity 414f, the movable member 32f is received in the accommodation cavity 414f The gap is defined between the movable member 32f and an inner wall of the accommodation portion 413f. The gap is 0.12 mm, 0.14 mm, 0.16 mm, 0.2 mm, 0.3 mm, 0.4 mm, 0.5 mm, 0.6 mm, 0.7 mm, 0.8 mm, 0.9 mm, 1 mm, 1.5 mm, 2 mm, 2.5 mm, 3 mm, 3.5 mm, 4 mm, 4.5 mm, or 5 mm. The driving assembly 33f is configured to drive the movable member 32f to linearly reciprocate in the accommodation cavity 414f, so as to generate periodic alternating positive and negative pressures at the first opening 11f.

The first sub-housing 111f defines a through hole (not labeled), and the accommodation portion 413f is at least partially accommodated in the through hole. The first sub-housing 111f can be made of a skin-friendly material, such as silicone, rubber, or plastic.

The inner wall of the first sub-housing 111f defines a groove 113f, a side wall 4131f of the accommodation portion 413f is received in the groove 113f, and the movable member 32f and the side wall 4131f of the accommodation portion 413f cooperatively defines the gap. The movable member 32f passes through a bottom wall 4132f of the accommodation portion 413f and extends in the accommodation cavity 414f. The first sub-support housing 411f defines a receiving groove 415f, and the first sub-housing 111f is at least partially received in the receiving groove 415f in a detachable manner. It should be understood that, the accommodation portion 413f can be regarded as a side wall of the receiving groove 415f User can easily separate the first sub-housing 111f from the first sub-support housing 411f for cleaning.

The movable member 32f can be a piston. The accommodation portion 413f can be used as a piston cavity structure. That is, the piston cavity structure is integrally formed with the first sub-support housing 411f It should be understood that, the accommodation portion 413f can be regarded as the first housing as mentioned above.

The first sub-housing 111f is internally provided with the temperature adjusting member 20f which may be the semiconductor chilling plate or the heating coil. The massaging device 100f may also include other kinds of temperature adjusting member as described in the first embodiment to the fifth embodiment.

The massaging device 100f may also include the pressure sensor, the temperature at the first opening 11f can be adjusted according to the pressure value collected by the pressure sensor. The massaging device 100f may also include the electrode sheet, the electrode sheet is received in the first opening. The massaging device 100f may also include the battery and the second circuit board.

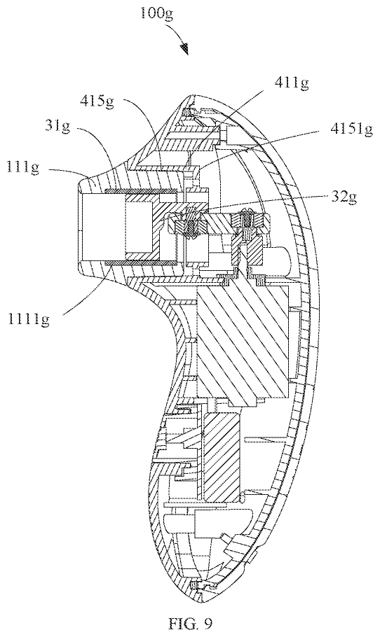

Referring to FIG. 9, a seventh embodiment of the present disclosure provides a massaging device 100g, the structure of the massaging device 100g is similar to the massaging device 100f. The differences between the two at least include: the first housing 31g is received in the first sub-housing 111g, and the gap is formed between the movable member 32g of the negative pressure generator 30g and the inner wall of the first housing 31g, the gap is greater than 0.1 mm and no greater than 5 mm, and the first housing 31g is integrally formed with the first sub-housing 111g by injection molding or other means.

The first sub-housing 111g defines a groove 1111g, and the first housing 31g is received in the groove 1111g. The first sub-support housing 411g defines a receiving groove 415g, and the first sub-housing 111g is at least partially received in the receiving groove 415g. Specifically, the first sub-housing 111g and the first housing 31g is detachably received in the receiving groove 415g, so the first sub-housing 111g is detachably connected with the first sub-support housing 411g. The first sub-housing 111g defines a via hole (not labeled), the movable member 32g may pass through a bottom wall 4151g of the receiving groove 415g and the via hole and extend in the first housing 31g. The first housing 31g includes the second opening 311g and the receiving space 312g, the movable member 32g extends in the receiving space 312g, the drive assembly 33g is configure to drive the movable member 32g to reciprocate in the receiving space 312g, to generate periodic alternating positive and negative pressures at the first opening 11g and the second opening 311g.

It should be understood that, the massaging device 100g also includes the temperature adjusting members as described in the first embodiment to the fifth embodiment.

The first sub-housing 111g is internally provided with the temperature adjusting member 20g which may be the semiconductor chilling plate or the heating coil. The massaging device 100g may also include other kinds of temperature adjusting member as described in the first embodiment to the fifth embodiment.

The massaging device 100g may also include the pressure sensor, the temperature at the first opening 11g can be adjusted according to the pressure value collected by the pressure sensor. The massaging device 100g may also include the electrode sheet, the electrode sheet is received in the first opening. The massaging device 100f may also include the battery and the second circuit board.

The above description is merely some embodiments. It should be noted that for one with ordinary skills in the art, improvements can be made without departing from the concept of the present disclosure, but these improvements shall fall into the protection scope of the present disclosure.

1. A massaging device (100a, 100b, 100c, 100d, 100e, 100f, 100g) for massaging erogenous zones of a human body, comprising:
an outer housing (10a, 10e, 10f, 10g) comprising a massage portion (110a), the massage portion (110a) defining a first opening (11a, 11e, 11f, 11g);
at least one temperature adjusting member (20a, 20b, 20c, 20d, 20e, 20g), to heat the massaging erogenous zones;
a negative pressure generator (30a, 30b, 30c, 30d, 30e, 30f, 30g), received in the outer housing (10a, 10e, 10f, 10g); and
a driving assembly (33a, 33b, 33c, 33d, 33e, 33f, 33g), received in the outer housing (10a, 10e, 10f, 10g)
wherein the negative pressure generator (30a, 30b, 30c, 30d, 30e, 30f, 30g) comprises a first housing (31a, 31b, 31c, 31d, 31g) received in the outer housing (10a, 10g) and a movable member (32a, 32b, 32c, 32d, 32g); the first housing (31a, 31b, 31c, 31d, 31g) defines a second opening (311a, 311b, 311c, 311d, 311g) and a receiving space (312a, 312b, 312c, 312d, 312g) communicated with the second opening (311a, 311b, 311c, 311d, 311g); the movable member (32a, 32b, 32c, 32d, 32g) extends into the receiving space (312a, 312b, 312c, 312d, 312g), and the movable member (32a, 32b, 32c, 32d, 32g) is configured to reciprocate in the receiving space (312a, 312b, 312c, 312d, 312g) driven by the driving assembly (33a, 33b, 33c, 33d, 33g), to generate the alternating positive and negative pressures at the first opening (11a, 11g) and the second opening (311a, 311b, 311c, 311d, 311g);
the first housing (31a, 31b, 31c, 31d, 31g) and the massage portion are two separate parts and made of different materials; and the first housing (31a, 31b, 31c, 31d, 31g) and the massage portion (110a) remain undeformed under actions of the negative pressure and the positive pressure.

2. The massaging device (100a, 100b, 100c, 100d, 100g) according to claim 1, wherein
a gap (313a) is defined between the movable member (32a, 32b, 32c, 32d, 32g) and the first housing (31a, 31b, 31c, 31d, 31g), the gap (313a) is greater than 0.1 mm and no greater than 5 mm.

3. The massaging device (100g) according to claim 2, wherein the outer housing (10g) comprises a sub-housing (111g), the first housing (31g) is integrally formed with the sub-housing (111g), the sub-housing (111g) comprises the massage portion.

4. (canceled)

5. The massaging device (100a, 100b, 100c, 100d, 100e, 100g) according to claim 1, wherein the temperature adjusting member (20a, 20b, 20c, 20d, 20e, 20g) is at least one of a semiconductor chilling plate, a heating coil, and an infrared heating assembly.

6. The massaging device (100a, 100b, 100c, 100d, 100e, 100g) according to claim 5, wherein the temperature adjusting member (20a, 20b, 20c, 20d, 20e, 20g) is the infrared heating assembly, the infrared heating assembly comprises:
a circuit board (21a, 21c); and
at least one LED red globe lamp (22a, 22c), electrically connected with the circuit board (21a, 21c), the LED red globe lamp (22a, 22c) is configured to face the first opening (11a) and provide infrared heating.

7. The massaging device (100a, 100b, 100c, 100d, 100e, 100g) according to claim 6, wherein the infrared heating assembly further comprises:
a cover plate (23a, 23c), configured to cover the LED red globe lamp (22a, 22c), the cover plate (23a, 23c) is transparent, or the cover plate (23a, 23c) is transparent and waterproof.

8. The massaging device (100a, 100b, 100c, 100d, 100g) according to claim 1, wherein
the temperature adjusting member (20a) is accommodated in an accommodating space (323a) defined in the movable member (32a).

9. The massaging device (100a, 100b, 100c, 100d, 100g) according to claim 1, wherein the negative pressure generator (30a) further comprises:
a sealing member (35a), sleeved on the movable member (32a), and the gap (313a) is defined between the sealing member (35a) and the inner wall of the first housing (31a).

10. The massaging device (100a, 100b, 100c, 100d) according to claim 1, further comprising:
a support housing (40a), defining a third opening (41a) communicated with the first opening (11a) and the second opening (311a), the first housing (31a) is received in the support housing (40a), and the outer housing (10a) is sleeved on the support housing (40a).

11. The massaging device (100b, 100c, 100d) according to claim 1, further comprising:
a second housing (36b, 36c, 36d), connected with a side of the first housing (31b, 31c, 31d) away from the movable member (32b, 32c, 32d), the second housing (36b, 36c, 36d) defines a through hole (361b, 361c, 361d) communicated with the second opening (311b, 311c, 311d), and the temperature adjusting member (20b, 20c, 20d) is arranged in the second housing (36b, 36c, 36d).

12. The massaging device (100b, 100c, 100d) according to claim 11, wherein the second housing (36b, 36c, 36d) is flexible.

13. The massaging device (100b, 100c, 100d) according to claim 11, wherein the temperature adjusting member (20b, 20c, 20d) is provided on a side of the second housing (36b, 36c, 36d) away from the first housing (31b, 31c, 31d).

14. The massaging device (100a, 100b, 100c, 100d, 100e, 100g) according to claim 1, wherein the temperature adjusting member (20a, 20b, 20c, 20d, 20e, 20g) is disposed adjacent to the first opening (11a, 11g).

15. The massaging device (100a, 100b, 100c, 100d, 100e, 100g) according to claim 1, further comprising:
an electrode sheet (13a), received in the first opening (11a).

16. The massaging device (100a, 100b, 100c, 100d, 100e, 100g) according to claim 1, further comprising:
a battery (14a); and
a circuit board (15a), the temperature adjusting member (20a) is electrically connected with the battery (14a) and the circuit board (15a).

17. The massaging device (100a, 100b, 100c, 100d, 100e, 100g) according to claim 1, further comprising:
at least one pressure sensor (17e), received in the outer housing (10e) and disposed adjacent to the first opening (11e).

18. (canceled)

19. The massaging device (100f) according to claim 1, wherein the negative pressure generator (30f) comprises:
a support housing (40f), comprising an accommodation portion (413f); and
a movable member (32f), extended into the accommodation portion (413f), a gap is defined between the movable member (32f) and the accommodation portion (413f), the gap is greater than 0.1 mm and no greater than 5 mm, and the movable member (32f) is configured to reciprocate in the accommodation portion (413f) driven by the driving assembly (33f), to generate the alternating positive and negative pressures at the first opening (11f).

20. The massaging device (100f) according to claim 19, wherein the support housing (40f) defines a receiving groove (415f), the outer housing (10f) comprises a sub-housing (111f), the sub-housing (111f) is at least partially received in the receiving groove (115f) in a detachable manner.

21. The massaging device (100a) according to claim 2, wherein the movable assembly (32a) defines a reciprocation direction, and a sectional size perpendicular to the reciprocation direction of the first opening (11a) is substantially same as a sectional size perpendicular to the reciprocation direction of the second opening (311a).

22. The massaging device (100a) according to claim 1, wherein the massage portion defines a heating space along a periphery thereof, the at least one temperature adjusting member (20a, 20b, 20c, 20d, 20e, 20g) is placed in the heating space.
